(19) United States
(12) Patent Application Publication
(10) Pub. No.: US 2013/0060492 A1
(43) Pub. Date: Mar. 7, 2013

(54) Method of deducing time based metrics using flow rate

(71) Applicants: James Stabile, JR., Newton, NJ (US); Anthony Valenzano, Archbald, PA (US)

(72) Inventors: James Stabile, JR., Newton, NJ (US); Anthony Valenzano, Archbald, PA (US)

(73) Assignee: TECHOX INDUSTRIES IND., Wilkes Barre, PA (US)

(21) Appl. No.: 13/605,017

(22) Filed: Sep. 6, 2012

Related U.S. Application Data
(60) Provisional application No. 61/531,393, filed on Sep. 6, 2011.
(60) Provisional application No. 61/531,331, filed on Sep. 6, 2011.

(51) Int. Cl. G01F 1/68; G06F 19/00

(52) U.S. Cl. 702/45

(57) ABSTRACT

A method of deducing time based metrics using flow rate is disclosed. The method uses a thermal mass flow meter wherein the meter comprises a pipe housing and a sensor board with at least one heating element and at least two temperature sensors is located inside the pipe and where a microprocessor is programmed to calculate a flow rate based on a logarithmic function of difference between base line temperature difference between temperature sensors before heating element is turned on and a second temperature difference between the temperature sensors after heating element is turned on. Duration of gas supply is provided by using the measured flow rate and information of the gas supply.

### PRIORITY

This application claims priority of the U.S. provisional applications No. 61/531,393 and 61/531,331 both of which were filed on Sep. 6, 2011 and the contents of which are fully incorporated herein by reference.

### FIELD OF THE INVENTION

The present invention relates to measuring flow rate. More specifically the present invention relates to a method to deduce time based metrics using flow rate.

### BACKGROUND OF THE INVENTION

Thermal mass flow meters generally use combinations of heated elements and temperature sensors to measure the difference between static and flowing heat transfer to a fluid and infer its flow with knowledge of the fluid's specific heat and density. The fluid temperature is also measured and compensated for. If the density and specific heat characteristics of the fluid are constant, the meter can provide direct mass flow readout, and does not need any additional pressure temperature compensation over their specified range.

While all thermal flow meters use heat to make their flow measurements, there are two different methods for measuring how much heat is dissipated. Thermal flow meters using constant temperature differential have two temperature sensors—a heated sensor and another sensor that measures the temperature of the gas. Mass flow rate is computed based on the amount of electrical power required to maintain a constant difference in temperature between the two temperature sensors.

Thermal flow meter using a second method called a constant current method also has a heated sensor and another one that senses the temperature of the flow stream. The power to the heated sensor is kept constant. Mass flow is measured as a function of the difference between the temperature of the heated sensor and the temperature of the flow stream.

Technological progress has allowed the manufacture of thermal mass flow meters on a microscopic scale as MEMS sensors. These flow devices can be used to measure flow rates in the range of nanoliters or micro liters per minute. One advantage of MEMS sensors is their capability to read a wide range of flow rates. However, MEMS sensors are still very expensive and there is a need for a more affordable system capable of measuring accurately very low flow rates.

Thermal mass flow meter technology is commonly used for compressed air, nitrogen, helium, oxygen and natural gas. In fact, most gases can be measured as long as they are fairly clean and non-corrosive. For more aggressive gases, the meter may be made of specialty allows (e.g. Hastelloy®). Pre-drying the gas also helps to minimize corrosion.

There are various situations where it is desirable and/or necessary to receive time based metrics to show how long a supply of gas lasts. Such applications would be useful to provide such data for gas grilles, heaters, other cooking equipments, vehicles, large utility structures and vehicles including, but not limited to pipelines, maritime tankers, railroad cars, truck transports, air transports, holding tanks of all sizes. Such applications would be useful also for forklifts, floor buffers, and indoor utility vehicles for example.

U.S. Pat. No. 7,104,124 discloses a system for identifying the time remaining for a bottled gas supply to lapse. The system reads the pressure and/or flow rate and optionally the temperature of the gas container and converts the data to indicate the time the gas supply will last.

U.S. Pat. No. 6,244,540 discloses a system usable in a jet aircraft, where the system computes a safe flight level based on data of pressurized oxygen supply and the amount of fuel in the aircraft.

Accordingly, there is a need for devices and methods for measuring flow rate and calculating remaining gas/fluid supply in various situations and for various purposes. The method as disclosed herein provides an affordable accurate methods to of deducing time based metrics using flow rate measurement. Therefore, the current invention represents a significant improvement over prior art.

### SUMMARY OF THE INVENTION

It is an object of this invention to provide an economic method to deduce time based metric using flow rate measurement.

It is a further object of this invention to provide a method to predict duration of gas supply at any given time.

It is another object of this invention to provide a method to predict duration of a gas supply in various devices such as, gas grilles, heaters, other cooking equipment, vehicles, large utility structures and vehicles including pipelines, maritime tankers, railroad cars, and truck transports, air transports, holding tanks or all sizes.

It is yet another object of this invention to provide a method to predict duration of gas supply in wide range of machinery including forklifts, floor buffers, and indoor utility vehicles.

In accordance with a preferred embodiment of the present invention there is provided:

A method for determining time remaining for use of a gas or fluid supply at any given time, said method comprising the steps of:

a) providing a thermal mass flow meter, comprising: a housing; a power supply; an amplifier; a microprocessor; and a display; said housing having an inlet and an outlet for a gas or fluid flow, and said housing comprising a laminar flow element locating at the inlet and at least one sensor board having a top side and a bottom side; said sensor board comprising at least one heating element and at least one upstream temperature sensor and at least one downstream temperature sensor; said heating element being connected to the power supply regulated via a power supply enable line by the microprocessor; said amplifier being connected to the temperature sensors to amplify temperature readings and sending the amplified readings to the microprocessor connected to the flow display;
b) providing information of available gas supply to the microprocessor; and
c) programming the microprocessor to conduct the following steps:
i) reading a baseline temperature of the temperature sensors, selecting one upstream and one downstream sensor, and calculating a baseline temperature difference between the selected temperature sensors,
ii) signaling the power supply to turn on to heat the heating element,
iii) reading a second temperature reading of the temperature sensors after the heating element has been on for a period of time and calculating a second temperature difference between the selected temperature sensors,
iv) calculating a flow rate based on subtraction of base line difference from second temperature difference,
v) calculating time remaining for the gas supply based on flow rate of step iv), baseline temperature of one of the upstream temperatures sensors in step i) and information of available gas supply in step b),
vi) showing the time remaining on the display, and
vii) Signaling the power supply to turn off, and repeating steps i) through vi) once the gas flow is restabilized.

Preferred embodiments of this invention are illustrated in the accompanying drawings and will be described in more detail herein below.

### BRIEF DESCRIPTION OF THE DRAWINGS

FIG. 1 is a schematic drawing of the flow meter according to this disclosure.

FIG. 2 shows a vertical cross section of a sensor board of the flow meter. Direction of gas or fluid flow is indicated by the arrows.

FIG. 3 shows programming steps of the microprocessor to determine the flow rate and calculate the duration of the gas supply.

### DETAILED DESCRIPTION OF THE INVENTION

The method to determine the duration of the gas supply according to this disclosure uses a novel type of flow meter that measures an outbound flow rate of a desired gas resource and converts that flow rate into a time estimate by cross-referencing a ‘full-capacity’ number (starting point) against what is being removed from the source. The microprocessor is programmed to determine duration of the gas/fluid supply based on the full-capacity number and the flow rate and display the time estimate. This is accomplished by mounting a gas pressure sensor in line with the gas supply, and connecting the sensor to the microprocessor of the gas flow meter described herein. As a result a user may have a simple digital display showing the duration of the gas supply in time units.

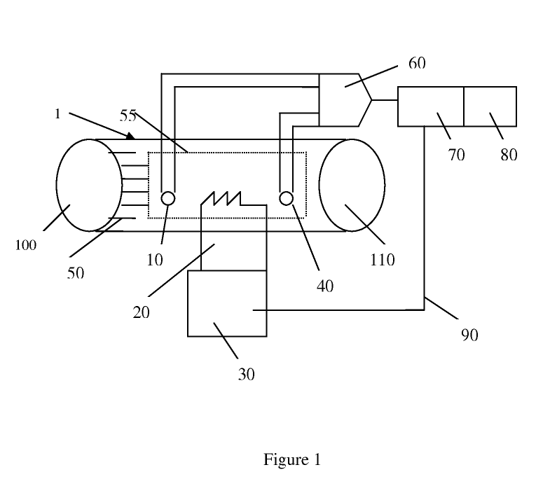

The preferred embodiments of the present invention will now be described with reference to FIGS. 1, 2 and 3 of the drawings.

FIG. 1 is a schematic drawing of the preferred embodiment of the flow meter of this invention. FIG. 1 shows a housing 1, a first temperature sensor (upstream sensor) 10, a heating element 20, a power supply 30, a second temperature sensor (downstream sensor) 40, a laminar flow element 50, a sensor board 55, amplifiers 60, microprocessor 70, flow display 80, power supply enable line 90, pipe inlet 100 and pipe outlet 110.

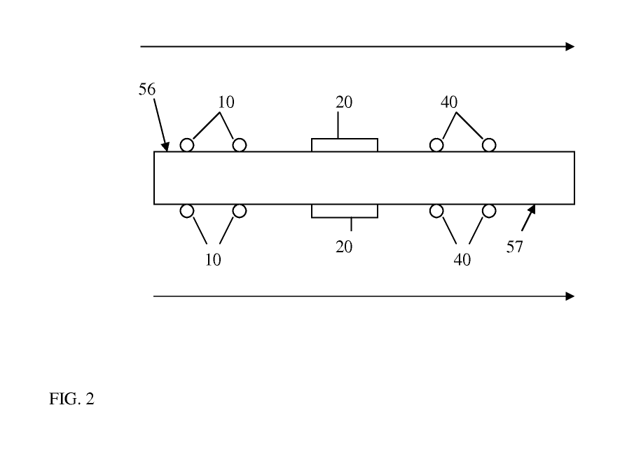

FIG. 2 shows a vertical cross section of a sensor board 55. The sensor board has a top side 56 and a bottom side 57. FIG. 2 shows a heating element 20 on both sides of the board and two temperature elements 10, 40 on both sides of the heating elements.

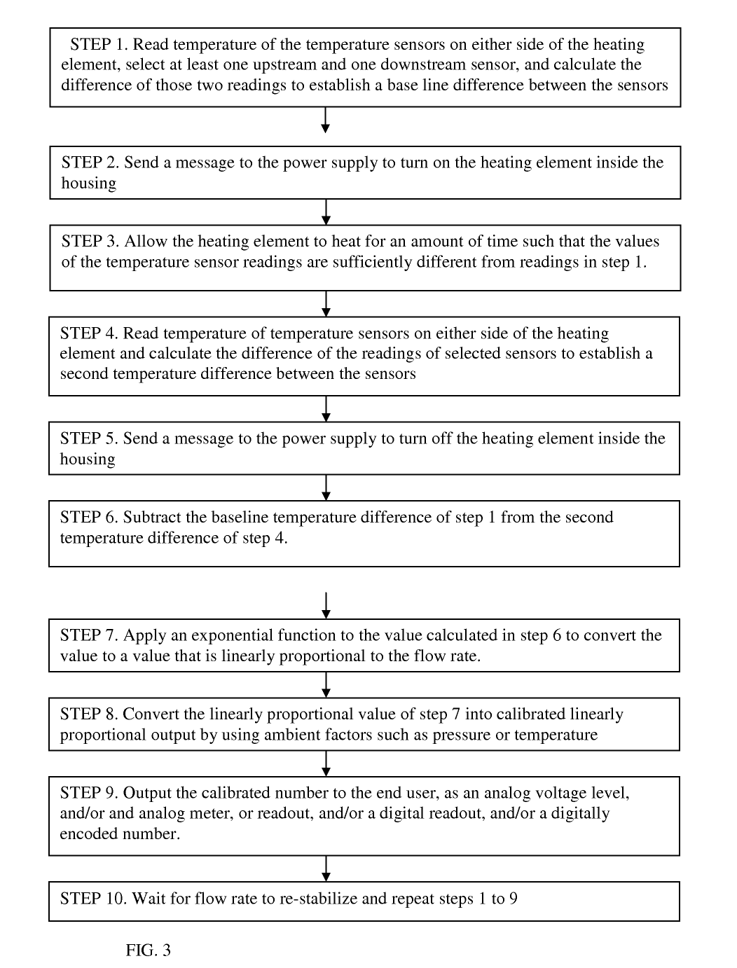

FIG. 3 shows the programming of the microprocessor.

Now referring to FIG. 1, the device according to this disclosure comprises a housing 1 that is preferably in a form of a pipe. The pipe has an inlet 100 and an outlet 110 for the gas or fluid to flow through. The housing 1 comprises a laminar flow element 50, and a sensor board 55. The sensor board 55 comprises a heating element 20 and at least one upstream temperature sensor 10, and at least one down stream temperature sensor 40. The temperature sensors are wired to amplifiers 60 that increase the signal level of the sensors when presented to a microprocessor 70. The information generated by the microprocessor 70 is displayed on a flow display 80.

The temperature sensors 10, 40 used in this invention may be analog sensors, such as MCP9700/9700A or MCP9700/9701A manufactured by Microchip Technology Inc., Chandler Ariz.

The heating element 20 used in this invention is preferably a resistor, such as RCL121810ROFKFK by Digi-Key Corp., Thief River Falls, Minn.

The microprocessor 70 used in this invention may be for example PIC 24FJ64GA004-1/PT by Digi-Key Corp., Thief River Falls, Minn.

The material of the housing pipe depends on the type of gas or fluid that is measured and conditions where the measurements are to be conducted. According to one preferred embodiment the housing is made of brass, but other alloys may also be used.

According to one preferred embodiment the housing is 2 to 5 inches long, and more preferably 3 inches long. According to one preferred embodiment the interior diameter of the housing pipe is ¼ to 1 inches and more preferably ½ inches.

According to one preferred embodiment the housing is attached to a source of gas flow (appliance), for example a gas container, with a ¼″ NPT threaded connection. According to this embodiment the housing would be located after the appliance regulator.

According to another preferred embodiment the housing is attached to a source of gas flow (appliance) with a QCC fitting. According to this embodiment the housing is before the appliance regulator.

The laminar flow element 50 is preferably located near the inlet of the pipe 100 so as to enable laminar flow of the gas or fluid without turbulences that would make the measurements inaccurate. The laminar flow element preferably comprises a multitude of small pipes. According to one preferred embodiment the laminar flow element is a pipe having a diameter of about 0.5 inches and is made of 50 smaller tubes with a diameter of 0.1 inches bundled together.

The sensor board 55 is preferably located in middle of the housing pipe, where the gas or fluid is flowing, not in periphery of the pipe as is disclosed for example in U.S. Pat. No. 7,895,888, which is incorporated herein by reference. The sensor board may locate close to the inlet or close to the outlet, but preferably it is located in about the middle section of the housing pipe 1.

The sensor board 55 comprises at least two temperature sensors 10, 40 and a heating element 20. The sensors are located on both sides of the heating element upstream of the flow (upstream sensors) and downstream of the flow (downstream sensors). The distance between each sensor and the heating element may be equal but does not necessarily need to be equal. Two sensors (one upstream sensor and one down stream sensor) is a minimum number of sensors according to this disclosure but a plurality of sensors may as well be used.

According to one preferred embodiment there is more than one temperature sensor on one side of the heating element and the same number of temperature sensors on the other side of the heating element 20. However, the number of the sensor on one side of the heating element does not necessarily need to be the same as on the other side of the heating element. The temperature sensors are located perpendicularly to the direction of the flow. According to a preferred embodiment the housing is a pipe, and the temperature sensors locate perpendicularly to the longitudinal axis of the housing pipe. FIG. 2 illustrates one embodiment with two sensors on each side of the heating element.

According to a preferred embodiment 2-10 sensors are used, according to a more preferable embodiment 4-6 sensors are used. According to a preferred embodiment there are 4 sensors on a board, 2 on both sides of the heating element (i.e. two upstream sensors and two downstream sensors).

Now referring to FIG. 2, FIG. 2 shows another preferred embodiment of the sensor board located inside the housing pipe. According to this embodiment the sensor board 55 has a top side 56 and a bottom side 57 and it is located in center of the gas/fluid flow. According to this embodiment the sensor board 55 has one heating element 20 and at least one upstream sensor 10 and at least one downstream sensor 40 on its top side 56 and optionally one heating element 20 and at least one upstream sensor 10 and one down stream sensor 40 on its bottom side 57. In FIG. 2 there are on both sides of the board a heating element and two upstream sensors and two downstream sensors. According to this embodiment the microprocessor takes readings for sensors on both sides of the sensor board and averages the results. The microprocessor may also calculate the flow rates above the board and beneath the board and average the flow rates to get a final rate that is used to calculate the duration of the gas/fluid supply. This embodiment is preferred in that it would help minimize effects causing flow to favor one side of the board, such as tilting of the board.

According to one preferred embodiment the flow meter has more than one sensor boards 55. According to this embodiment each sensor board 55 has a heating element 20 and at least two temperatures sensors 10, 40.

The sensors and the heating element are secured on the sensor board for example by an adhesive. The sensor board may be made of any feasible material, including plastics and metal alloys.

The heating element is connected to a power supply 30 which is turned on and off by power supply enable line 90 operated by the microprocessor 70. The power supply is preferably a battery.

The two or more temperature sensors are connected to an amplifier 60 that amplifies the signal before being presented to the microprocessor 70.

Once the gas or fluid flow is set to run through the housing 1, a baseline reading of the plurality of the temperature sensors 10, 40 is taken before the heating element 20 is powered by the power supply 30. The heating element is enabled by the power supply enable line 90 operated by the microprocessor. The heating element is allowed to heat the gas/fluid for a period of time that is sufficient for the temperature sensors to read changed values, preferably about one second. A second reading of the temperature sensors is made at this time. Heating element 20 is now turned off, preferably for about 15 seconds to re-stabilize the flow before a new baseline measurement is done.

The microprocessor is programmed to select two temperature sensors, one upstream and one downstream sensor to calculate a difference of the temperatures measured before the heating element was turned on (baseline difference). The microprocessor calculates difference of the temperatures measured by the same sensor at the second reading. The microprocessor is programmed to turn the heating element off after the measurements. The microprocessor is programmed to subtract the baseline reading from a difference of temperatures measured at the second reading. This provides the micro-processor 70 with a temperature difference due to the imbalance in thermal energy added by the heating element 20. This imbalance is logarithmically proportional to the flow rate. The micro-processor 70 converts the final number from the temperature sensor reading into calibrated flow rate using pressure and temperature as factors. The calibrated number will be played on flow display. Once the measurement is done, the micro-processor will wait until the temperature differences in the housing pipe are restabilized (preferably about 15 seconds), a new baseline reading is taken from each temperature sensor, the heating element is turned on for a short period of time and a second reading is made. The difference between the baseline readings in temperature sensors is subtracted from the difference of between the second reading and the flow rate is calculated based on the imbalance.

According to one preferred embodiment the microprocessor is programmed to calculate temperature differences between more than one sensor pair at same time.

In a preferred embodiment there is a gas pressure sensor mounted in line directly to the gas supply and the sensor is attached to the microprocessor of the flow meter. The microprocessor uses the initial pressure reading as ‘full capacity’—reading and calculates duration of the supply based on the flow rate measurement. The duration of time is displayed on the display.

Now referring to FIG. 3. In step 1 the microprocessor reads the temperature of temperature sensors on either side of the heating element. The microprocessor is programmed to select a pair of sensors consisting of one upstream sensor and one downstream sensor, and calculate the difference of the temperature readings of the two selected sensors to establish a base line temperature difference between the selected sensors.

In step 2 the microprocessor is programmed to send a message to the power supply to turn on the heating element inside the housing.

In step 3 the microprocessor is programmed to allow the heating element to heat for an amount of time that is such that the values of the temperature sensor readings are sufficiently different from readings of step 1. The heating element is preferably turned on for 0.1 to 10 seconds, more preferably for 0.5 to 5 seconds and most preferably for one second. This heating period is generating temperature increase of approximately 1 to 50° F., more preferably 5 to 20° F. and most preferably approximately 10° F.

In step 4 the microprocessor is programmed to read temperature of the temperature sensors on either side of the heating element and calculate the difference of the temperature readings of the sensors selected in step 1 to establish a second temperature difference between the selected sensors.

In step 5 the microprocessor is programmed to send a message to the power supply to turn off the heating element inside the housing to allow the flow to re-stabilize. Preferably the heating element is turned off for about 15 seconds before it can be turned on again for a new measurement.

In step 6 the microprocessor is programmed to subtract the baseline temperature difference of step 1 from the second temperature difference of step 4. This value is a temperature difference due to the imbalance in the thermal energy added by the heating elements. This imbalance is logarithmically proportional to the flow rate.

In step 7 the microprocessor is programmed to apply an exponential function to the value calculated in step 6 to convert the value to a value that is linearly proportional to the flow rate.

In step 8 the microprocessor is programmed to convert the linearly proportional value of step 7 to a calibrated linearly proportional output by using ambient factors such as pressure or temperature. In this step the microprocessor may use a pressure reading taken by a pressure sensor optionally mounted to the gas source, where said reading was taken preferably before step 1. The microprocessor may be programmed to calculate a ‘full-capacity’ number for the original gas supply by using the pressure reading and the base line temperature reading of the upstream temperature sensor. Alternatively the full-capacity-number may be manually provided to the microprocessor. The microprocessor calculates duration of time of the gas supply based on the calculated gas flow and the ‘full capacity’-number.

In step 9 the microprocessor is programmed to output the calibrated number to the end user, as an analog voltage level, and/or and analog meter, or readout, and/or a digital readout, and/or a digitally encoded number.

In step 10 the microprocessor is programmed to wait for flow rate to re-stabilize and repeat steps 1 to 9.

According to one preferred embodiment the microprocessor may be programmed to select more than one pair of sensors in step 1 and make the calculations for readings of one heating cycle for multiple sensor pairs simultaneously.

According to another preferred embodiment the microprocessor may be programmed to measure temperature of selected sensors after the heating element has been turned off in step 5 and make the calculations of steps 1 to 9. This embodiment would allow to follow movement of a temperature pulse created by turning the heating element on and to calculate gas/fluid velocity when the distance between temperature sensors is known. This number may be used to deduce the duration of the supply at the measured gas/fluid velocity.

According to one preferred embodiment, the sensor board has top and a bottom side and each side has a heating element connected to the power supply and each side has at least one upstream temperature sensor and at least one downstream temperature sensor. This embodiment is shown in FIG. 2. In this embodiment the microprocessor is programmed to conduct the following steps:
1) reading a baseline temperature of the temperature sensors on the top side of the sensor board and calculating a baseline temperature difference between one selected upstream sensor and one selected downstream sensor,
2) simultaneously with step 1) reading a baseline temperature of the temperature sensors on the bottom side of the sensor board and calculating a baseline temperature difference between one selected upstream sensor and one selected downstream sensor,
3) signaling the power supply to turn on to heat the heating elements,
4) reading a second temperature reading of the temperature sensors on the top side of the sensor board after the heating element has been on for a period of time and calculating a second temperature difference between the selected temperature sensors,
5) reading a second temperature reading of the temperature sensors on the bottom side of the sensor board after the heating element has been on for a period of time and calculating a second temperature difference between the selected temperature sensors,
6) calculating a flow rate above the sensor board based on subtraction of base line difference from the second temperature difference measured from the sensors on the top side of the sensor board,
7) calculating a flow rate beneath the sensor board based on substraction of base line difference from second temperature difference measured from the sensors on the bottom side of the sensor board,
8) averaging the results of steps 6) and 7) to receive a final flow rate,
9) calculating time remaining for the gas supply based on flow rate of step 8), baseline temperature of one of the temperatures sensors in step 1) and information of available gas supply,
10) showing the time remaining on a display, and
11) Signaling the power supply to turn off, and repeating steps 1) through 10) once the gas flow is restabilized.
The microprocessor may receive information of available gas supply in step 9) by reading gas pressure through a gas pressure meter and using temperature reading of one of the temperature sensors in step 1), or the information may be manually provided to the processor.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method for determining time remaining for use of a gas or fluid supply at any given time, said method comprising the steps of:
a) providing a thermal mass flow meter, comprising:
a housing;
a power supply;
an amplifier;
a microprocessor; and
a display;
said housing having an inlet and an outlet for a gas or fluid flow, and said housing comprising a laminar flow element locating at the inlet and at least one sensor board having a top side and a bottom side;
said sensor board comprising at least one heating element and at least one upstream temperature sensor and at least one downstream temperature sensor;
said heating element being connected to the power supply regulated via a power supply enable line by the microprocessor;
said amplifier being connected to the temperature sensors to amplify temperature readings and sending the amplified readings to the microprocessor connected to the flow display;
b) providing information of available gas supply to the microprocessor; and
c) programming the microprocessor to conduct the following steps:
viii) reading a baseline temperature of the temperature sensors, selecting one upstream and one downstream sensor, and calculating a baseline temperature difference between the selected temperature sensors,
ix) signaling the power supply to turn on to heat the heating element,
x) reading a second temperature reading of the temperature sensors after the heating element has been on for a period of time and calculating a second temperature difference between the selected temperature sensors,
xi) calculating a flow rate based on subtraction of base line difference from second temperature difference,
xii) calculating time remaining for the gas supply based on flow rate of step iv), baseline temperature of one of the upstream temperatures sensors in step i) and information of available gas supply in step b),
xiii) showing the time remaining on the display, and
xiv) Signaling the power supply to turn off, and repeating steps i) through vi) once the gas flow is restabilized.

2. The method of claim 1, wherein in step b) a gas pressure sensor is mounted on the gas supply and the microprocessor reads the sensor.

3. The method of claim 1 wherein in step b) the information is manually provided to the microprocessor.

4. The method of claim 1, wherein the power supply is a battery.

5. A method for determining time remaining for use of a gas or fluid supply at any given time, said method comprising the steps of:
a) providing a thermal mass flow meter, comprising:
a housing;
a power supply;
an amplifier;
a microprocessor; and
a display;
said housing having an inlet and an outlet for a gas or fluid flow, and said housing comprising a laminar flow element locating at the inlet and a sensor board having a top side and a bottom side;
said sensor board comprising two heating elements, one locating on the top side and one on the bottom side, and at least one upstream temperature sensor and at least one downstream temperature sensor;
said heating elements being connected to the power supply regulated via a power supply enable line by the microprocessor;
said amplifier being connected to the temperature sensors to amplify temperature readings and sending the amplified readings to the microprocessor connected to the display;
b) providing information of available gas supply to the microprocessor; and
c) programming the microprocessor to conduct the following steps:
i) reading a baseline temperature of the temperature sensors on the top side of the sensor board, selecting one upstream and one downstream temperature sensor, and calculating a baseline temperature difference between the selected temperature sensors,
ii) simultaneously with step i) reading a baseline temperature of the temperature sensors on the bottom side of the sensor board, selecting one upstream and one downstream temperature sensors and calculating a baseline temperature difference between the selected temperature sensors,
iii) signaling the power supply to turn on to heat the heating elements,
iv) reading a second temperature reading of the temperature sensors on the top side of the sensor board after the heating element has been on for a period of time and calculating a second temperature difference between the selected temperature sensors,
v) reading a second temperature reading of the temperature sensors on the bottom side of the sensor board after the heating element has been on for a period of time and calculating a second temperature difference between the selected temperature sensors,
vi) calculating a flow rate above the sensor board based on subtraction of base line difference from second temperature difference measured from the sensors on the top side of the sensor board,
vii) calculating a flow rate beneath the sensor board based on subtraction of base line difference from second temperature difference measured from the sensors on the bottom side of the sensor board,
viii) averaging the results of steps vi) and vii) to receive a final flow rate,
ix) calculating time remaining for the gas supply based on flow rate of step viii), baseline temperature of one of the temperatures sensors in step i) and information of available gas supply in step b),
x) showing the time remaining on a display, and
xi) Signaling the power supply to turn off, and repeating steps i) through ix) once the gas flow is restabilized.

6. The method of claim 5, wherein in step b) a gas pressure sensor is mounted on the gas supply and the microprocessor reads the sensor.

7. The method of claim 5 wherein in step b) the information is manually provided to the microprocessor.

8. The method of claim 5, wherein the power supply is a battery.
